(19) United States
(12) Patent Application Publication
(10) Pub. No.: US 2020/0125062 A1
(43) Pub. Date: Apr. 23, 2020

(54) METHOD FOR COMPENSATING TEACHING POSITIONS

(71) Applicant: FANUC CORPORATION, Yamanashi (JP)

(72) Inventors: Toshihiko INOUE, Yamanashi (JP); Tomoyuki MOTOKADO, Yamanashi (JP); Kazuhiro WATANABE, Yamanashi (JP)

(73) Assignee: FANUC CORPORATION, Yamanashi (JP)

(21) Appl. No.: 16/594,296

(22) Filed: Oct. 7, 2019

(30) Foreign Application Priority Data
Oct. 17, 2018 (JP) 2018-195554

(51) Int. Cl. G05B 19/401; B23K 20/00; B25J 9/16; B23K 11/11; B23K 9/12; G05B 19/042

(52) U.S. Cl. CPC G05B 19/401; B23K 20/004; B25J 9/163; B23K 11/115; G05B 2219/45138; G05B 19/042; G05B 2219/40099; G05B 2219/45104; G05B 2219/40581; B23K 9/121

(57) ABSTRACT

A method for compensating teaching positions which includes: generating a compensation start point and a compensation end point in positions where each of a number of teaching positions is sandwiched between the compensation start point and the compensation end point in a direction crossing a welding path, the number of teaching positions being set along the welding path of a welding base material; detecting a profile of the welding base material along a detection path by performing touch sensing while a welding torch is being moved along the detection path from the generated compensation start point toward the generated compensation end point, a welding wire protruding from the welding torch; and compensating each of the teaching positions based on the detected profile.

### CROSS-REFERENCE TO RELATED APPLICATIONS

This application claims the benefit of Japanese Patent Application No. 2018-195554, the content of which is incorporated herein by reference.

### FIELD

The present invention relates to a method for compensating teaching positions.

### BACKGROUND

Conventionally, there has been known touch sensing in which a welding wire protruded from a tip end of a welding torch is caused to contact a welding base material and a position of the tip end of the welding torch is thereby detected (for example, see Japanese Unexamined Patent Application, Publication No. 2001-225288).

In Japanese Unexamined Patent Application, Publication No. 2001-225288, through the touch sensing performed by causing the welding wire to contact an outer surface of the welding base material, displacement of the welding base material is detected, and a transformation matrix for compensating the detected displacement is generated, thereby correcting a teaching position.

### SUMMARY

One aspect of the present invention is a method for compensating teaching positions, which includes: generating a compensation start point and a compensation end point in positions where each of a plurality of teaching positions is sandwiched between the compensation start point and the compensation end point in a direction crossing a welding path, the plurality of teaching positions being set along the welding path of a welding base material; detecting a profile of the welding base material along a detection path by performing touch sensing while a welding torch is being moved along the detection path from the generated compensation start point toward the generated compensation end point, a welding wire being protruded from the welding torch; and compensating each of the teaching positions based on the detected profile.

### BRIEF DESCRIPTION OF THE DRAWINGS

FIG. 1 is an overall configuration diagram illustrating a robot system that implements a method for compensating teaching positions according to one embodiment of the present invention.

FIG. 2 is a perspective view illustrating one example of welding base materials to which the method for compensating teaching positions in FIG. 1 is applied.

FIG. 3 is a front view illustrating relationship of a welding torch which is included in the robot system in FIG. 1 and the welding base materials.

FIG. 4 is a flowchart showing the method for compensating teaching positions in FIG. 1.

FIG. 5 is a diagram showing one example of a detection path which is set in the teaching positions in the method for compensating teaching positions in FIG. 4.

FIG. 6 is a front view illustrating a state in which a welding wire is located at a compensation start point in the robot system in FIG. 1.

FIG. 7 is a front view explaining touch sensing which is performed while the welding wire is being moved from the compensation start point in FIG. 6 along the detection path.

FIG. 8 is a front view illustrating a state in which the welding wire in FIG. 7 is located at a step difference of the welding base materials.

FIG. 9 is a front view explaining the touch sensing which is performed while the welding wire is being moved from the state illustrated in FIG. 8 up to a welding end point along the detection path.

FIG. 10 is a perspective view illustrating a modified example of the welding base materials in FIG. 2.

### DETAILED DESCRIPTION

Hereinafter, a method for compensating teaching positions according to one embodiment of the present invention will be described with reference to the accompanying drawings.

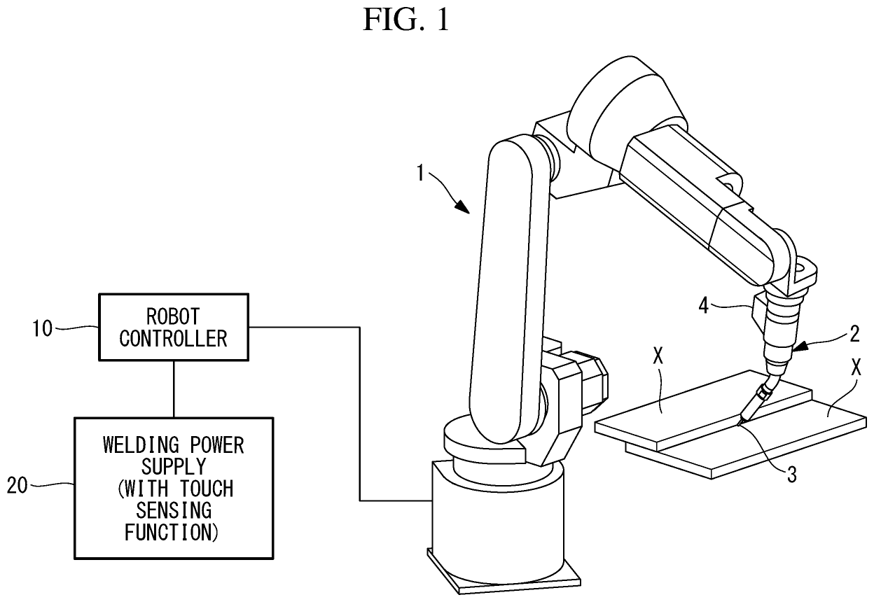

The method for compensating teaching positions according to the present embodiment is a method for compensating teaching positions of a robot 1, in which arc welding is performed with a welding wire 3 protruded from a tip end of a welding torch 2 which is attached at a tip end of the robot 1. As shown in FIG. 1, the robot 1 is, for example, a six-axis articulated type robot.

As shown in FIG. 1, connected to the robot 1 are a controller 10 which controls the robot 1 in accordance with a teaching program and a welding power supply 20 which has a touch sensing function.

The touch sensing function is a function to detect that the welding wire 3 contacts each welding base material X. The welding wire 3 is driven by a servo motor 4 with which the welding torch 2 is provided.

Specifically, the touch sensing function increases a protrusion amount when the welding wire 3 is not in contact with the welding base material X by sending the welding wire 3 forward through an operation of the servo motor 4 and decreases the protrusion amount when the welding wire 3 has contacted the welding base material X by drawing the welding wire 3 backward up to a position where the contacting of the welding wire 3 with the welding base material X is eliminated. The welding power supply 20 outputs, to the controller 10, the protrusion amount of the welding wire 3 in each position where the welding wire 3 is drawn to a base end side thereof.

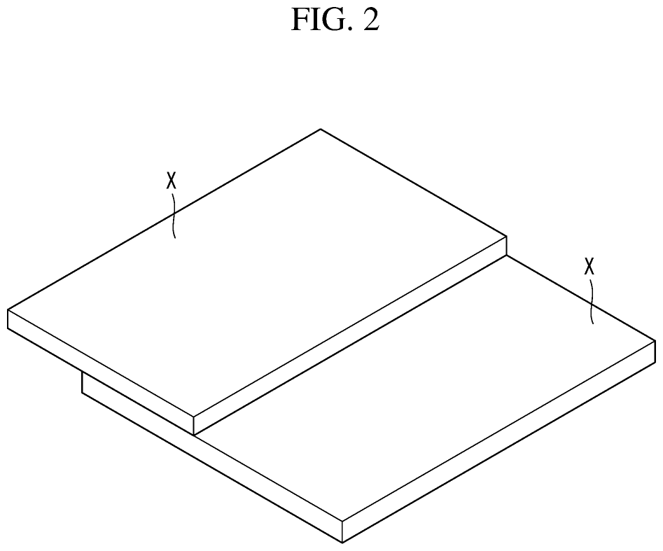

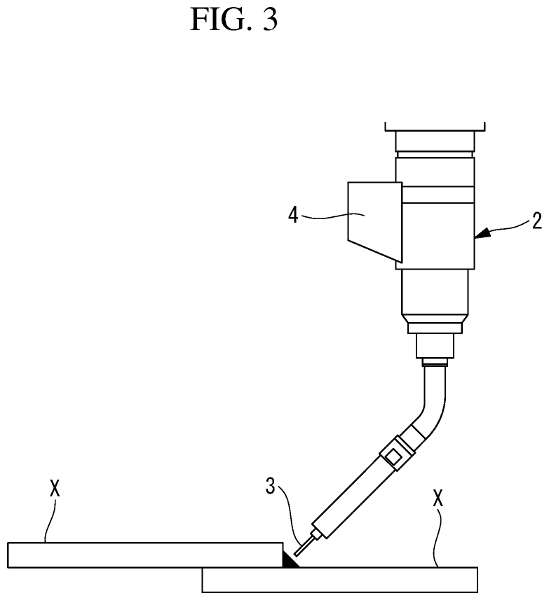

The method for compensating teaching positions according to the present embodiment is premised on a case in which for example, as shown in FIG. 2, two flat plate-like welding base materials X are overlapped with each other and are fixed by a fixture, not shown, on a table and a plurality of teaching positions are taught along a welding path along which fillet welding is performed along an end edge of one of the welding base materials X, as shown in FIG. 3. When the arc welding is performed while the welding torch 2 is being moved in such a way as to travel along the plurality of teaching positions by an operation of the robot 1, even by fixing the similar welding base materials X by the same fixture, the welding path may be displaced due to positional displacement of the welding base materials X upon fixing the welding base materials X, dimensional errors of the welding base materials X themselves, and the like.

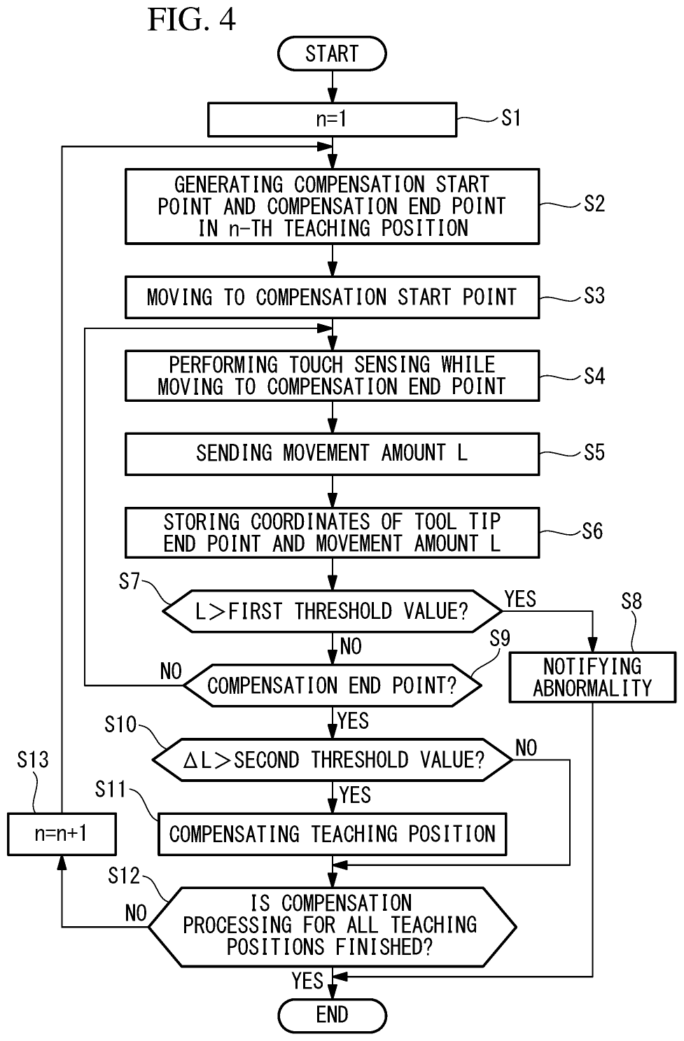

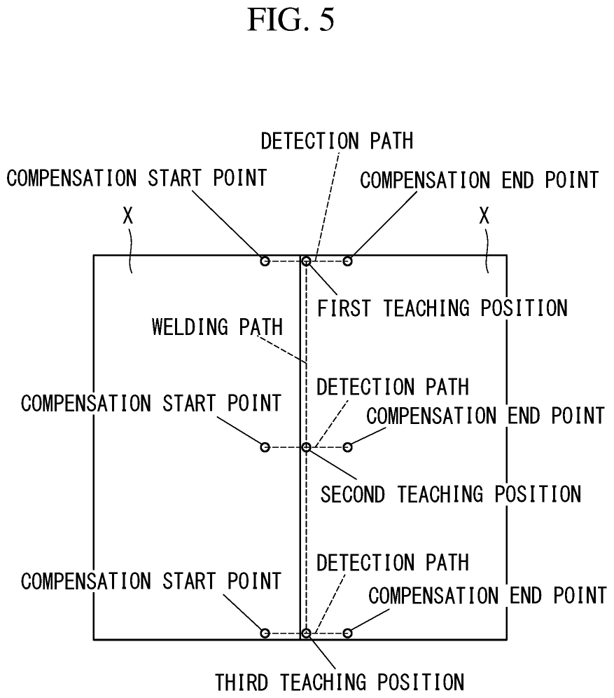

The method for compensating teaching positions according to the present embodiment is implemented with the welding base materials X fixed by the fixture prior to actual welding, and for example, for all of the plurality of teaching positions which are set along the welding path, respective compensation operations are conducted. In the compensation operations, as shown in FIG. 4, n is initialized (Step S1), and for a first teaching position, a compensation start point and a compensation end point are generated on both sides of a direction crossing the welding path, between which the teaching position is sandwiched (Step S2). As shown in FIG. 5, the compensation start point and the compensation end point are set at a predetermined distance on a straight line (detection path) passing through the teaching position.

The welding wire 3 is protruded from a tip end of the welding torch 2 by a predetermined amount, for example, 15 mm, and a position at which a tip end of the welding wire 3 is thereby located is set as a tool tip end point which serves as an operational reference for the robot 1.

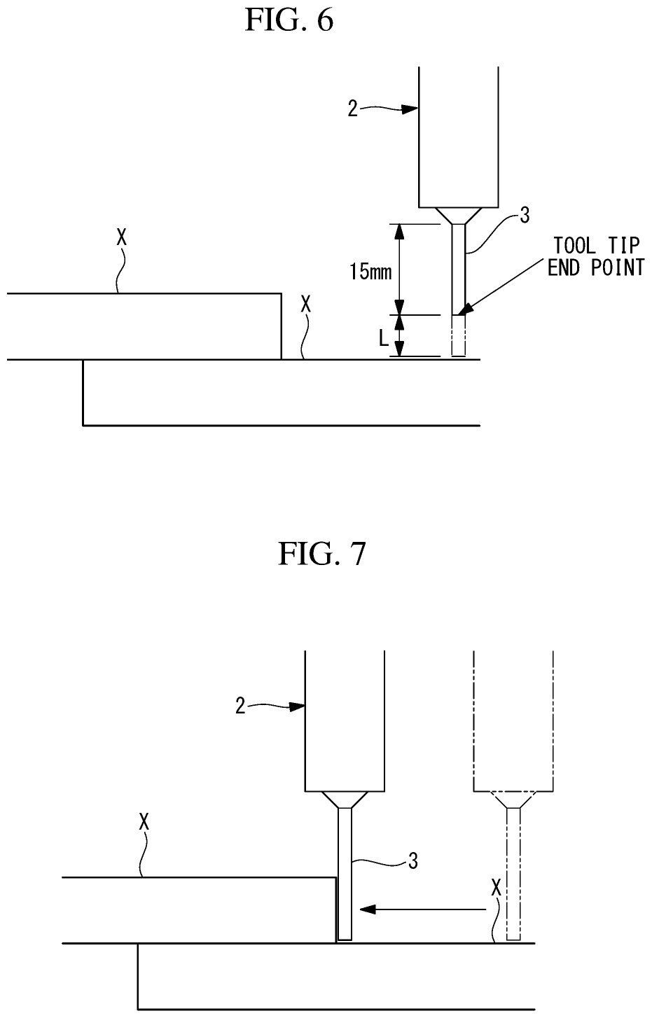

As shown in FIG. 6 to FIG. 9, the controller 10 moves the welding torch 2 from the generated compensation start point to the generated compensation end point along the detection path while maintaining a posture of the welding torch 2 in a direction in which a direction of the welding wire 3 is orthogonal to a surface of each of the welding base materials X. During that period, the welding power supply 20 sends the welding wire 3 outward and draws the welding wire 3 backward through the touch sensing function and as shown in FIG. 6, detects a movement amount L of the welding wire 3 from the tool tip end point, thereby detecting a position of the surface.

In other words, first, the tool tip end point is moved to the compensation start point (Step S3), and while the tool tip end point is being moved toward the compensation end point along the detection path, the touch sensing is performed (Step S4). Thus, in the position in which the welding wire 3 is not in contact with the welding base material X on the detection path, the welding wire 3 is protruded, whereas when the welding wire 3 has contacted the welding base material X, the welding wire 3 is drawn in such a way as to reach a position in which the welding wire 3 comes not to contact the welding base material X.

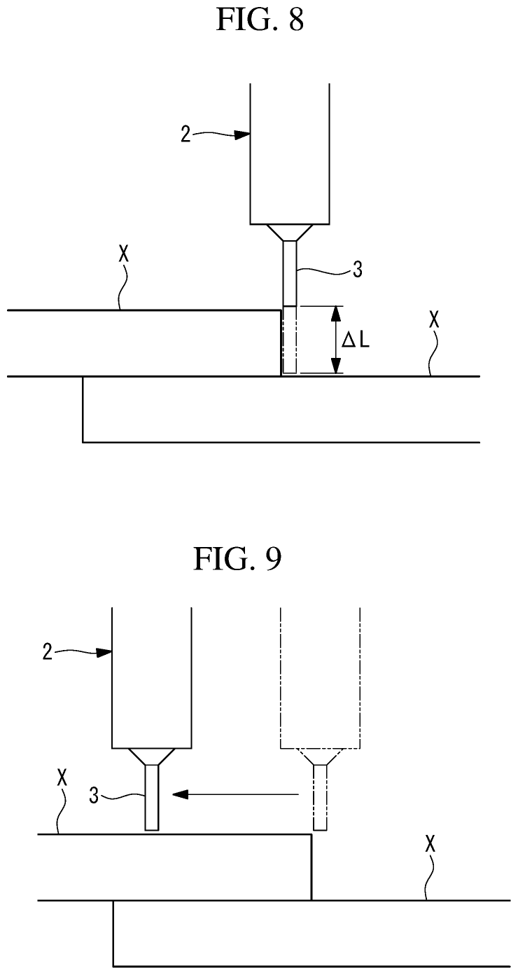

In a portion in which a shape of the surface of the welding base material X is flat, a change amount (absolute value) ΔL of the movement amount L of the welding wire 3 is extremely small, whereas in a portion of a step difference which the welding base materials X have, as shown in FIG. 8, the change amount ΔL of the movement amount L of the welding wire 3 becomes large. A movement amount L of the welding wire 3 from the tool tip end point upon drawing the welding wire 3 backward is sent to the controller 10 (Step S5).

When the movement amount L of the welding wire 3 is sent from the welding power supply 20, the controller 10 stores coordinates of the tool tip end point at this point in time and the sent movement amount L so as to be associated with each other (Step S6) and determines whether or not an absolute value of the movement amount L is larger than a first threshold value (Step S7). The first threshold value is an allowable movement amount of the welding wire 3 from the tool tip end point. The allowable movement amount is, for example, ±15 mm.

As a result of the determination at Step S6, when the movement amount L is larger than the first threshold value, the controller 10 notifies that the movement amount L is abnormal (Step S8) and finishes the processing. The notification method may be any method such as a method in which the movement amount is displayed on a screen or a method in which an alarm is sounded.

As a result of the determination at Step S6, when the movement amount L is less than or equal to the first threshold value, the controller 10 determines whether or not the tool tip end point is located at the compensation end point (Step S9) and when the tool tip end point is not located at the compensation end point, repeats the steps from Step S4.

When the tool tip end point is located at the compensation end point at Step S8, detection of a profile of the welding base material X along the detection path comes to an end.

Thereafter, based on the detected profile, the controller 10 detects a position of the step difference of the welding base materials X. In other words, the controller 10 determines whether or not the change amount ΔL of the movement amount L of the welding wire 3 from the compensation start point along the detection path exceeds a second threshold value (Step S10). When a maximum value of the change amount ΔL is less than or equal to the second threshold value, it is seen that the surface of the welding base material X is substantially flat along the detection path.

On the other hand, when the movement amount L of the welding wire 3 exceeds the second threshold value in the middle of the detection path, it is seen that in that position, a step difference whose thickness is greater than or equal to a plate thickness of the welding base material X is present on the surface of the welding base material X. Based on coordinates of the tool tip end point and a movement amount L of the welding wire, which are stored so as to be associated with this position, compensation of the teaching positions is conducted (Step S11).

In other words, by detecting a profile of the welding base material X along the detection path, a position of the step difference on the welding base materials X, that is, an end edge of one of the welding base materials X, which is overlapped on a surface of the other of the welding base materials X, and that is, a welding path which is subjected to the fillet welding is precisely detected. Each of the previously taught teaching positions is replaced with each of new teaching positions calculated based on the detected welding path.

It is determined whether or not for all of the teaching positions, compensation processing is conducted (Step S12), and when the compensation processing for all of the teaching positions has been conducted, the processing is finished and when the compensation processing for all of the teaching positions has not been conducted, n is incremented (Step S13) and the steps from Step S2 are repeated.

As described above, the method for compensating teaching positions according to the present embodiment has the advantage that since with the welding base materials X fixed by the fixture, the teaching positions are compensated based on the profile of each of welding base materials X, which is detected prior to the actual welding, even when the welding base materials X are fixed by the fixture in a state in which the welding base materials X are rotated as a whole or even when due to errors of the shape of each of the welding base materials X themselves, displacement between an end edge of the welding base materials X and the taught welding path occurs, respective teaching positions on the welding path can be precisely compensated so as to coincide with a position of the actual end edge of the welding base material X.

In addition, according to the present embodiment, since upon detecting the profile, the welding wire 3 is maintained in the direction which is orthogonal to the surface of each of the welding base materials X, the coordinates of the detected tool tip end point in the direction along the surface of the welding base material X substantially coincide with coordinates of the tip end of the welding wire 3. In addition, since based on the movement amount L of the welding wire 3 from the tool tip end point, each of the teaching positions is compensated, based on the coordinates of the detected tool tip end point in the direction which is orthogonal to the surface of each of the welding base materials X and the movement amount L of the welding wire, the coordinates of the tip end of the welding wire 3 in the direction which is orthogonal to the surface of each of the welding base materials X can be easily calculated.

In other words, according to the present embodiment, the advantages that the positional displacement of the welding base materials X and the displacement, which are caused by the errors of the shape of each of the welding base materials X, can be three-dimensionally precisely detected and that the teaching positions can be three-dimensionally precisely compensated are exhibited. In particular, even when the errors of the shape of each of the welding base materials X are partially large, welding can be precisely performed in accordance with a shape of each of the welding base materials X in reality.

In addition, since when the movement amount L of the welding wire 3 exceeds the first threshold value, the notification in relation thereto is made and the processing is finished, when the welding base materials X are fixed in a largely displaced manner or errors of the shape of each of the welding base materials X are excessively large, such welding base materials X can be excluded from welding base materials targeted for the welding.

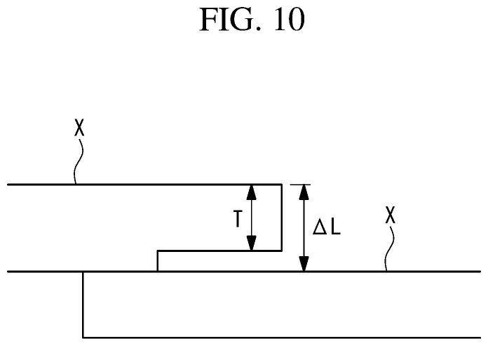

In addition, since as the second threshold value, the plate thickness dimension of each of the welding base materials X is set, when a magnitude ΔL of the step difference, which is detected by the touch sensing function, exceeds a plate thickness dimension T, as shown in FIG. 10, it also can be detected that a space between the two welding base materials X is present. In such a case, welding conditions upon the arc welding, which are suited for fillet welding for welding base materials X having the space therebetween, can also be set.

Note that although in the method for compensating teaching positions according to the present embodiment, based on the profile detected from the compensation start point to the compensation end point along the detection path, each of the teaching positions is compensated, instead of this, the profile is detected from the compensation start point and at a point in time when the step difference is detected, the processing of detecting the profile may be finished. This allows a period of time, for which the profile is detected, to be shortened.

In addition, although the detection path is set in the direction which is orthogonal to the welding path, instead of this, a detection path in a direction which crosses the welding path at any angle may be set.

In addition, as each of a value by which the position of the tip end of the welding wire 3 is protruded to set the tool tip end point and a value of the allowable movement amount, any value other than 15 mm may be adopted.

In addition, the welding power supply 20 has the touch sensing function and the servo motor 4 included in the welding torch 2 is controlled, thereby moving the welding wire 3. However, the servo motor 4 for moving the welding wire 3 may be configured by an auxiliary axis of the robot 1 and based on a contact detection signal obtained by the touch sensing function of the welding power supply 20 when the welding wire 3 has contacted the welding base material X, the controller 10 may control the servo motor 4.

In addition, in the present embodiment, for all of the teaching positions taught along the welding path, the detection paths are set and compensated. Instead of this, however, when only angle deviation of each of the whole welding base materials X is compensated, correct teaching positions as to two positions which are apart from each other along the welding path may be obtained by the detection of the profile and based on an angle between the obtained teaching positions, the angle deviation of each of the welding base materials X may be compensated.

From the above-described embodiment, the following invention is derived.

One aspect of the present invention is a method for compensating teaching positions, which includes: generating a compensation start point and a compensation end point in positions where each of a plurality of teaching positions is sandwiched between the compensation start point and the compensation end point in a direction crossing a welding path, the plurality of teaching positions being set along the welding path of a welding base material; detecting a profile of the welding base material along a detection path by performing touch sensing while a welding torch is being moved along the detection path from the generated compensation start point toward the generated compensation end point, a welding wire being protruded from the welding torch; and compensating each of the teaching positions based on the detected profile.

According to the present aspect, for each of the plurality of teaching positions which are set along the welding path of the welding base material, the compensation start point and the compensation end point are generated in the positions where each of the plurality of teaching positions is sandwiched between the compensation start point and the compensation end point in the direction crossing the welding path. By performing the touch sensing while the welding torch is being moved along the detection path from the generated compensation start point toward the generated compensation end point, the welding wire being protruded from the welding torch, the profile of the welding base material along the detection path is detected.

Since the profile shows a change in a surface shape of the welding base material, the presence of a step difference, that is, the welding path in a portion where the surface shape abruptly changes can be detected. Accordingly, based on the profile showing the actual welding path, each of the teaching positions is compensated, thereby allowing not only displacement of each of the teaching positions, caused by displacement of the whole welding base materials, but also displacement of each of the teaching positions, caused by errors of the welding base materials themselves to be compensated.

In the above-described aspect, a tip end position of the welding wire being protruded from a tip end of the welding torch by a predetermined amount may be set as a tool tip end point, and in the touch sensing, an operation, in which the welding wire is protruded, performed when contact of the welding wire and the welding base material is not detected and an operation, in which the welding wire is drawn back, performed when the contact of the welding wire and the welding base material is detected may be repeated, and coordinates of the tool tip end point and a movement amount of the welding wire from the tool tip end point at a point in time when the contact of the welding wire and the welding base material is detected may be recorded.

By this configuration, contacting of the welding wire and the welding base material and separating of the welding wire and the welding base material are repeated by moving the welding wire in a length direction while the welding torch is being moved along the detection path. At a point in time when the welding wire has contacted the welding base material, the coordinates of the tool tip end point and the movement amount of the welding wire are recorded, thereby allowing the profile of the welding base material along the detection path to be easily detected.

In addition, in the above-described aspect, when an absolute value of the movement amount of the welding wire, recorded by the touch sensing, is larger than a first threshold value, notification in relation to the absolute value being larger than the first threshold value may be made.

By this configuration, since when the absolute value of the movement amount of the welding wire in the touch sensing is larger than the first threshold value, displacement of each of the teaching positions is excessively large, the notification in relation thereto is made, thereby allowing an operator to be notified of abnormality.

In addition, in the above-described aspect, when the absolute value of the movement amount of the welding wire, recorded by the touch sensing, is less than or equal to the first threshold value and is larger than a second threshold value, the welding path is determined as being detected and based on coordinates of the tool tip end point and a movement amount of the welding wire from the tool tip end point at a point in time when the welding path is determined as being detected, each of the teaching positions may be compensated.

By this configuration, when the absolute value of the movement amount of the welding wire in the touch sensing has largely changed in a range of the first threshold value or less, it can be easily determined that the welding path in the portion where the surface shape of the welding base material abruptly changes has been detected. By using the coordinates of the tool tip end point and the movement amount of the welding wire at the above-mentioned point in time, the position of the actual welding path is used, thereby allowing not only the displacement of each of the teaching positions, caused by the displacement of the whole welding base materials, but also the displacement of each of the teaching positions, caused by the errors of the welding base materials themselves to be compensated.

1. A method for compensating teaching positions, the method comprising:
generating a compensation start point and a compensation end point in positions where each of a plurality of teaching positions is sandwiched between the compensation start point and the compensation end point in a direction crossing a welding path, the plurality of teaching positions being set along the welding path of a welding base material;
detecting a profile of the welding base material along a detection path by performing touch sensing while a welding torch is being moved along the detection path from the generated compensation start point toward the generated compensation end point, a welding wire protruding from the welding torch; and
compensating each of the teaching positions based on the detected profile.

2. The method for compensating teaching positions according to claim 1, wherein
a tip end position of the welding wire protruding from a tip end of the welding torch by a predetermined amount is set as a tool tip end point, and
in the touch sensing, an operation, in which the welding wire is protruded, performed when contact of the welding wire and the welding base material is not detected and an operation, in which the welding wire is drawn back, performed when the contact of the welding wire and the welding base material is detected are repeated, and coordinates of the tool tip end point and a movement amount of the welding wire from the tool tip end point at a point in time when the contact of the welding wire and the welding base material is detected are recorded.

3. The method for compensating teaching positions according to claim 2, wherein when an absolute value of the movement amount of the welding wire, recorded by the touch sensing, is larger than a first threshold value, notification in relation to the absolute value being larger than the first threshold value is made.

4. The method for compensating teaching positions according to claim 3, wherein when the absolute value of the movement amount of the welding wire, recorded by the touch sensing, is less than or equal to the first threshold value and is larger than a second threshold value, the welding path is determined as being detected and based on coordinates of the tool tip end point and a movement amount of the welding wire from the tool tip end point at a point in time when the welding path is determined as being detected, each of the teaching positions is compensated.
